(19) United States
(12) Patent Application Publication
(10) Pub. No.: US 2025/0179945 A1
(43) Pub. Date: Jun. 5, 2025

(54) SPROCKET AND METHOD FOR PROCESSING THE SAME

(71) Applicant: Schaeffler Technologies AG & Co. KG, Herzogenaurach (DE)

(72) Inventors: Xin Li, Suzhou (CN); Yanhua He, Jiangsu (CN)

(73) Assignee: Schaeffler Technologies AG & Co. KG, Herzogenaurach (DE)

(21) Appl. No.: 18/842,398

(22) PCT Filed: Mar. 3, 2022
(86) PCT No.: PCT/CN2022/079092

§ 371 Date: Aug. 29, 2024

(51) Int. Cl. F01L 1/344

(52) U.S. Cl. CPC F01L 1/344

(57) ABSTRACT

The present disclosure relates to a sprocket and a method for processing a sprocket. The sprocket includes an annular main body portion and a plurality of sprocket teeth circumferentially arranged around the radial outer side of the main body portion. The sprocket further comprises annular cushion rings and adhesive tape arranged on the radial outer side of the main body portion, and the cushion rings are bonded to the radial outer side of the main body portion through the adhesive tape. According to the present disclosure, the cushion rings are directly bonded to the sprocket through the adhesive tape, thereby simplifying the manufacturing process, reducing costs, and reducing the noise when a chain is in contact with the sprocket.

### CROSS-REFERENCE TO RELATED APPLICATIONS

This application is the U.S. National Phase of PCT Application No. PCT/CN2022/079092 filed on Mar. 3, 2022, the entire disclosure of which is incorporated by reference herein.

### TECHNICAL FIELD

The present disclosure relates to the technical field of sprocket drives, and in particular to a sprocket and a camshaft phaser and a method for processing the sprocket.

### BACKGROUND

Currently, a sprocket of a camshaft in a vehicle engine is provided with cushion rings to improve the noise and vibration performance when an engine chain is in contact with the sprocket. In the present process, cushion rings are bonded to a sprocket via an adhesive, and the relevant process involves first forming the sprocket at a powder metallurgy supplier, then transporting it to a rubber supplier for bonding and rubber stretching and then returning it to the powder metallurgy supplier for processing, and then finally sending the finished product to the customer.

The existing process for bonding cushion rings has the following problems: 1. The bonding requirements of the adhesive are high and it is expensive; the bonding process has high requirements for product quality and process parameters; in order to ensure good bonding effects, the processes such as steam treatment, deep cleaning and sand blasting are added, and the longer adhesive bonding process and many steps result in high product costs; 2. Multiple procedures are repeated, resulting in waste and high costs; products need to be transferred between different suppliers, which results in high costs for packaging, transportation, storage and production management; interprocess corrosion protection is required due to transfer between different suppliers, the anti-corrosion medium needs to be cleaned to ensure the quality of adhesive coating, and the added interprocess corrosion protection does not increase the value of products but instead causes waste; and since the bonding process requires high cleanliness of adhesive surfaces of the sprocket, the adhesive surfaces need to be cleaned repeatedly during the transportation between different suppliers, and these cleaning procedures do not add value to the products but instead cause waste; and 3. There are many factors that affect product quality during the current bonding process with the result that product quality is difficult to control; incomplete cleaning of the anti-corrosion medium may affect the quality of the adhesives, and the bonding performance of adhesives is very sensitive to the oil and water content of the sprocket and may change during transfer and storage, ultimately affecting the bonding quality of the adhesives, and scaling, scratches and impacts during the packaging and transportation of the products may occur, thereby increasing the rejection rate.

### SUMMARY

In order to solve the above technical problems, the present disclosure provides a sprocket and a camshaft phaser, and a method for processing the sprocket.

The sprocket for an engine provided by an embodiment of the present disclosure comprises: An annular main body portion, and a plurality of sprocket teeth circumferentially arranged around the radial outer side of the main body portion; and the sprocket further comprises annular cushion rings and adhesive tape arranged on the radial outer side of the main body portion, wherein the cushion rings are bonded to the radial outer side of the main body portion through the adhesive tape.

According to some example embodiments of the present disclosure, both axial sides of the sprocket teeth are provided with a cushion ring bonded to the radial outer side of the main body portion through adhesive tape.

According to some example embodiments of the present disclosure, the radial outer side of the cushion ring has a plurality of convex portions corresponding to the sprocket teeth.

According to some example embodiments of the present disclosure, the adhesive tape is bonded to the radial outer side of the main body portion.

According to some example embodiments of the present disclosure, the adhesive tape is bonded to the axial side of the sprocket teeth.

According to some example embodiments of the present disclosure, the adhesive tape is a pressure-sensitive adhesive tape or a heat-sensitive adhesive tape.

According to some example embodiments of the present disclosure, the cushion ring is made of an elastic material.

An example embodiment of the present disclosure further provides a camshaft phaser comprising the sprocket described above, a stator, a rotor and lock pins, wherein the sprocket, the stator and the rotor are concentrically arranged; the sprocket is provided with lock pin holes, the stator and the sprocket are connected through the coordination of the lock pin holes and the lock pins, and the rotor is rotatably arranged on the radial inner side of the stator.

An example embodiment of the present disclosure further provides a method for processing the cushion rings for a sprocket that is applied to the sprocket described above, wherein the adhesive tape is bonded to the radial outer side of the main body portion or to the axial side of the sprocket teeth, and the cushion rings are bonded to the radial outer side of the main body portion through the adhesive tape.

According to some example embodiments of the present disclosure, the bonding method is direct pressure bonding, heat bonding, or heat pressure bonding.

In the technical field of vehicle drive, the present disclosure provides a sprocket and a camshaft phaser, and a method for processing the sprocket to achieve noise reduction when a chain is in contact with the sprocket. The cushion rings are directly bonded to the sprocket through adhesive tape without using processes such as fumigation and shot blasting, thereby simplifying the manufacturing process; and the entire process of molding the sprocket and bonding the cushion rings through adhesive tape can be completed at the same supplier, thereby omitting much of the intermediate packaging and transfer procedures that add no value, and eliminating the repeated cleaning and repeated testing as well as the corrosion protection procedure in the original process;

the cushion ring supplier can efficiently produce cushion rings in large batches, thereby reducing costs; and there are few factors affecting the bonding process of the adhesive tape and full automation is realized at the sprocket supplier, thereby ensuring product quality while reducing production management and storage costs and the rejection rate of the products.

### BRIEF DESCRIPTION OF THE DRAWINGS

In order to explain the technical solutions of the example embodiments of the present disclosure more clearly, the accompanying drawings that needed to be used for the description of the example embodiments of the present disclosure will be briefly introduced below. Obviously, the accompanying drawings in the following description are only some example embodiments of the present disclosure, and those of ordinary skill in the art can obtained other accompanying drawings based on these accompanying drawings without expending any creative effort.

FIG. 1 is a three-dimensional perspective view of a camshaft phaser according to an example embodiment of the present disclosure;

FIG. 2 is a three-dimensional perspective view of a sprocket according to an example embodiment of the present disclosure;

FIG. 3 is an exploded perspective view of a sprocket according to an example embodiment of the present disclosure;

FIG. 4 is a front view of the coordination of a sprocket and a chain according to an example embodiment the present disclosure;

FIG. 5 is a partial cross-sectional view of a sprocket according to an example embodiment of the present disclosure; and

FIG. 6 is a partial cross-sectional view of a sprocket according to an example embodiment of the present disclosure.

It should be understood that the aforementioned accompanying drawings are not drawn to actual scale.

### DETAILED DESCRIPTION

In order to make the purposes, technical solutions and advantages of the example embodiments of the present disclosure clearer, the technical solution of the example embodiments of the present disclosure will be clearly and completely described below in conjunction with the accompanying drawings of the example embodiments of the present disclosure. Obviously, the described example embodiments are some, but not all, of the example embodiments of the present disclosure. Based on the described example embodiments of the present disclosure, all other example embodiments obtained by persons of ordinary skill in the art fall within the scope of protection of the present disclosure.

Unless otherwise defined, the technical terms or scientific terms used in the example embodiments of the present application shall have the usual meanings understood by those with ordinary skill in the art to which the present invention belongs. Similar words such as “comprise” or “include” used in the example embodiments of the present disclosure mean that the elements or items listed before the word cover the elements or items listed after the word and equivalents thereof, without excluding other elements or items. Terms such as “upper”, “lower”, and the like are used only with respect to the orientations of the components in the drawings, and these directional terms are relative concepts that are used to describe and clarify relative orientations, and may vary accordingly depending on the orientations in which the components in the drawings are located.

The purpose of the present disclosure is to provide a new product structure and process for bonding cushion rings to a sprocket that can simplify the bonding process and production management process, and thereby reduce costs and achieve higher production robustness.

The sprocket provided by the present disclosure can be applied to various devices using a sprocket drive such as camshaft phasers in engines. An illustrative description of the application of the sprocket to a camshaft phaser is provided below. It should be understood that the sprocket may also be applied to other equipment using a sprocket drive.

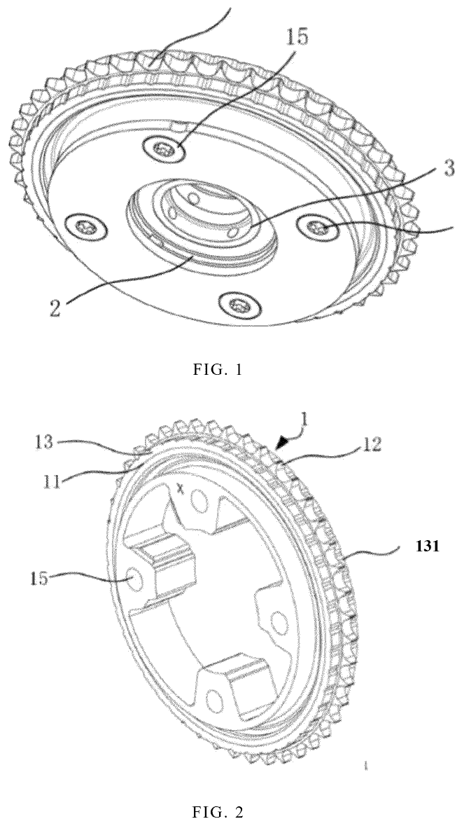

FIG. 1 is a perspective view of a camshaft phaser according to an example embodiment of the present disclosure. The camshaft phaser may be used in vehicle engines. As shown in FIG. 1, the camshaft phaser comprises a sprocket 1, a stator 2, a rotor 3 and lock pins 4, and the sprocket 1, the stator 2 and the rotor 3 are concentrically arranged. The sprocket I is provided with lock pin holes 15 disposed along the axial direction, and a plurality of lock pin holes 15 are evenly distributed on the sprocket 1 along the circumferential direction. The stator 2 and the sprocket 1 are connected through the coordination of the lock pin holes 15 and the lock pins 4, and the rotor 3 is rotatably arranged on the radial inner side of the stator 2.

Furthermore, FIG. 2 is a perspective view of the sprocket 1 according to an example embodiment of the present disclosure. As shown in FIG. 2, the sprocket 1 comprises an annular main body portion 11 and a plurality of sprocket teeth 12 circumferentially arranged around the radial outer side of the main body portion 11. The sprocket 1 further comprises annular cushion rings 13 and adhesive tape 14 arranged on the radial outer side of the main body portion 11, and the cushion rings 13 are bonded to the radial outer side of the main body portion 11 through the adhesive tape 14.

Specifically, the sprocket teeth 12 are used for meshing with a chain. In the radial direction, the height of the cushion ring 13 is less than that of the sprocket teeth 12 to enable the smooth meshing of the chain with the sprocket teeth 12. The cushion rings 13 are arranged on the radial outer side of the main body portion 11, such that the direct contact between the part of the chain meshing with the sprocket teeth 12 and the main body portion 11 is reduced, wherein the radial inner side of the chain acts on the cushion rings with a certain elasticity, thereby further reducing the frictional vibration and noise between the sprocket 1 and the chain.

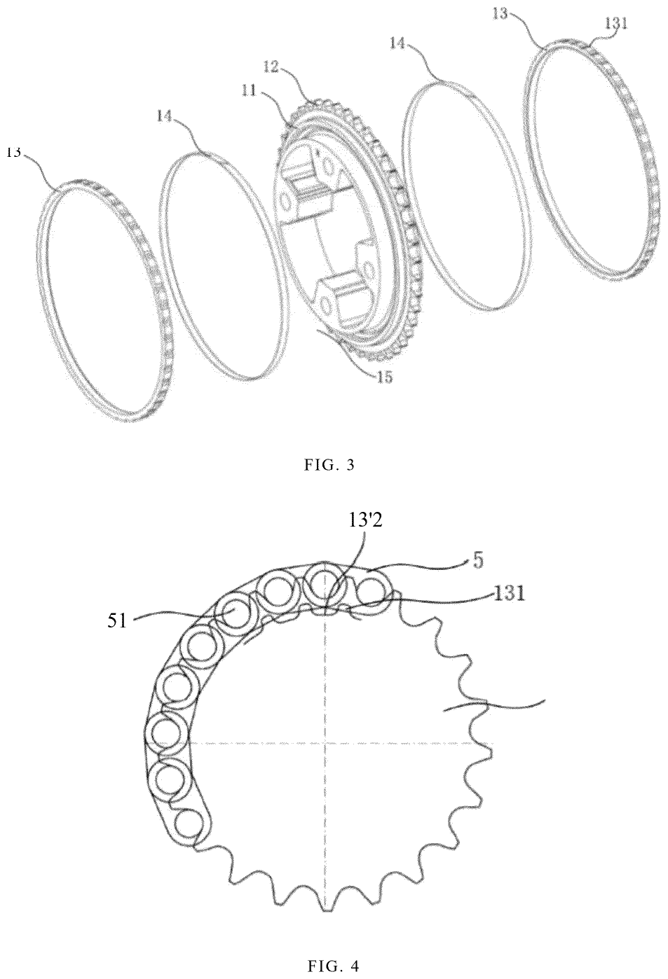

FIG. 3 shows an exploded perspective view of the sprocket 1 according to an example embodiment of the present disclosure. As shown in FIG. 2 and FIG. 3, both axial sides of the sprocket teeth 12 are provided with the cushion ring 13 bonded to the radial outer side of the main body portion 11 through the adhesive tape 14. Both axial sides of the sprocket teeth 12 are provided with the cushion ring 13 such that the direct contact between the chain and the main body portion 11 is reduced, and the meshing transmission between the chain and the sprocket 1 is more stable, thereby further improving the frictional vibration and noise between the sprocket 1 and the chain.

FIG. 4 is a front view of the coordination of the sprocket 1 and the chain 5 according to an example embodiment of the present disclosure. The radial outer side of the cushion ring 13 has a plurality of convex portions 131 corresponding to the sprocket teeth 12. A concave portion 132 is formed between every two convex portions. Specifically, for example, the chain links 51 of the chain 5 correspond to the concave portions 132, and a gap between the two chain links 51 of the chain 5 corresponds to the convex portion 131. In this way, the shape of a side surface, in contact with the cushion rings 13 on the radial inner side, of the part of the chain 5 that meshes with the sprocket 1 corresponds to the shape of the convex portions 131, and this enables a fuller fit between the chain 5 and the cushion rings 131, thereby further improving the frictional vibration and noise between the sprocket 1 and the chain 5. Optionally, the radial outer side of the cushion ring 13 may be provided in other shapes that can correspond to the chain 5 so as to enable more adequate contact between the chain 5 and the cushion rings 13 of the sprocket 1.

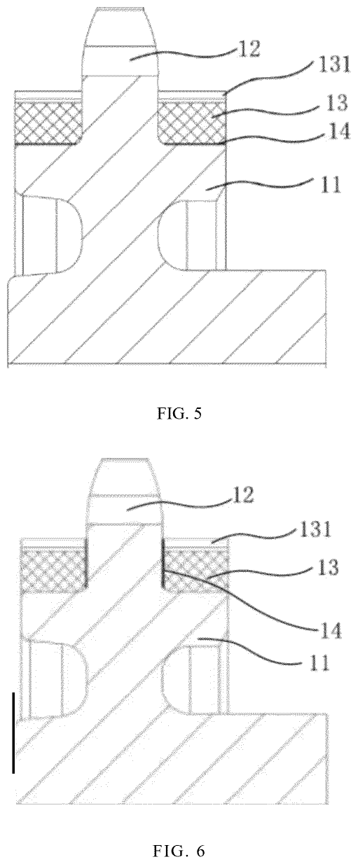

FIG. 5 is a partial cross-sectional view of a sprocket according to an example embodiment of the disclosure. As shown in FIG. 5, the adhesive tape 14 is bonded to the radial outer side of the main body portion 11. FIG. 6 is a partial cross-sectional view of a sprocket according to an example embodiment of the present disclosure. As shown in FIG. 5, the adhesive tape 14 is bonded to the axial side of the sprocket teeth 12. It is also possible that the adhesive tape 14 is arranged both on the radial outer side of the main body portion 11 and on the axial side of the sprocket teeth 12 to bond the cushion rings 13.

In some example embodiments, the adhesive tape 14 may be a pressure-sensitive adhesive tape or a heat-sensitive adhesive tape in order to firmly bond the cushion rings 13 to the radial outer side of the main body portion 11.

In some example embodiments, the cushion ring 13 is made of an elastic material like rubber such that the cushion ring can produce elastic deformation when the sprocket 1 meshes with the chain 5, thereby achieving a cushioning effect between the sprocket 1 and the chain 5 to reduce vibration and noise.

Furthermore, the adhesive tape 14 has a thickness that matches the spacing distance between the radial outer side of the main body portion 11 and the radial inner side of the chain 5. Optionally, the matched thickness can be slightly larger than the spacing distance between the radial outer side of the main body portion 11 and the radial inner side of the chain 5 to ensure that the cushion rings 13 can achieve a cushioning effect between the main body portion 11 and the chain 5, and at the same time, to ensure full meshing between the sprocket 1 and the chain 5.

An example embodiment of the present disclosure provides a method for processing the cushion rings 13 of a sprocket 1, and the method is applied to the sprocket 1 described above, wherein the method comprises:
bonding the adhesive tape 14 to the radial outer side of the main body portion 11, or to the axial side of the sprocket teeth 12; and
bonding the cushion rings 13 to the radial outer side of the main body portion 11 through adhesive tape 14.

Furthermore, the bonding method may be direct pressure bonding, heat bonding, or heat pressure bonding.

According to example embodiments of the present disclosure, the cushion rings 13 are directly bonded to the sprocket 1 by using heat-sensitive adhesive tape or pressure-sensitive adhesive tape instead of using an adhesive to bond the cushion rings 13 without using such processes as fumigation and shot blasting, thereby simplifying the manufacturing process; and the entire process of molding the sprocket I and bonding the cushion rings 13 through the adhesive tape 14 can be completed at the same supplier, thereby omitting a lot of intermediate packaging and transfer procedures that contribute no value, and eliminating the repeated cleaning, repeated testing and corrosion protection procedures in the original process; the cushion ring supplier can efficiently produce cushion rings in large batches, thereby reducing costs; and there are few influencing factors for the bonding process of the adhesive tape 14 and full automation is realized at the sprocket supplier, thereby ensuring product quality while reducing production management, storage costs and rejection rate of products.

It should be understood that the technical solution of the present disclosure, in which the cushion rings are bonded with adhesive tape such as pressure-sensitive adhesive tape or heat-sensitive adhesive tape, can be applied to any equipment that requires sprocket driving and is not limited to camshaft phasers of vehicle engines.

Although potential example embodiments have been described illustratively in the above description, it should be understood that there are still a large number of example embodiment variations that may be obtained by combinations of all of the known technical features and example embodiments as well as those that are readily apparent to those skilled in the art. In addition, it should be further understood that the example embodiments are merely examples and that these example embodiments shall not in any way limit the scope of protection, application and construction of the present disclosure. The foregoing description is intended more to provide those skilled in the art with a technical guide for converting at least one example embodiment, in which various changes, especially changes in the functions and structures of the components, can be made as long as they do not deviate from the scope of protection of the claims.

### LIST OF REFERENCE NUMERALS

1 Sprocket
11 Main body portion
12 Sprocket teeth
13 Cushion ring
131 Convex portion
132 Concave portion
14 Adhesive tape
15 Lock pin hole
2 Stator
3 Rotor
4 Lock pin
5 Chain
51 Chain link

1. A sprocket, comprising:
an annular main body portion,
a plurality of sprocket teeth circumferentially arranged around a radial outer side of the annular main body portion,
annular cushion rings configured to elastically receive a chain, and
adhesive tape arranged on the sprocket, and the annular cushion rings are bonded to the sprocket via the adhesive tape.

2. The sprocket according to claim 1, wherein one annular cushion ring of the annular cushion rings is arranged on each axial side of the plurality of sprocket teeth.

3. The sprocket according to claim 1, wherein a radial outer side of each of the annular cushion rings has a plurality of convex portions corresponding to the plurality of sprocket teeth.

4. The sprocket according to claim 1, wherein the adhesive tape is bonded to the radial outer side of the annular main body portion.

5. The sprocket according to claim 1, wherein the adhesive tape is bonded to an axial side of the plurality of sprocket teeth.

6. The sprocket according to claim 1, wherein the adhesive tape is a pressure-sensitive adhesive tape.

7. The sprocket according to claim 1, wherein the annular cushion rings is are made configured to elastically deform when receiving the chain.

8. A camshaft phaser, comprising:
the sprocket according to claim 1,
a stator configured to receive the sprocket,
a rotor rotatably disposed within the stator, and
the sprocket, the stator and the rotor are concentrically arranged.

9. A method for attaching cushion rings to a sprocket having a plurality of circumferentially arranged sprocket teeth, the method comprising:
bonding adhesive tape to the sprocket, the sprocket configured to receive a chain; and
bonding cushion rings to the sprocket via the adhesive tape.

10. The method according to claim 9, wherein the bonding of the adhesive tape and the cushion rings is direct pressure bonding.

11. The sprocket according to claim 1, wherein the adhesive tape is a heat-sensitive adhesive tape.

12. The sprocket according to claim 4, wherein one annular cushion ring of the annular cushions rings is arranged on each axial side of the plurality of sprocket teeth.

13. The sprocket according to claim 5, wherein one annular cushion ring of the annular cushion rings is arranged on each axial side of the plurality of sprocket teeth.

14. The method according to claim 9, wherein the bonding of the adhesive tape and the cushion rings is heat bonding.

15. A camshaft phaser, comprising:
a stator having:
a sprocket arranged circumferentially around the stator, the sprocket having a plurality of circumferentially arranged sprocket teeth configured to engage a chain,
a first elastic cushion ring arranged on a first axial side of the sprocket, and
a second elastic cushion ring arranged on a second axial side of the sprocket,
a rotor disposed within the stator, and
the first elastic cushion ring and the second elastic cushion ring are: i) configured to elastically receive the chain, and ii) fixed to the stator via adhesive tape.

16. The camshaft phaser of claim 15, wherein the first elastic cushion ring, the second elastic cushion ring, the stator, the sprocket, and the rotor are concentrically arranged.

17. The camshaft phaser of claim 15, wherein the adhesive tape is arranged on the first axial side and the second axial side of the sprocket.

18. The camshaft phaser of claim 15, wherein the adhesive tape is arranged on a radial outer side of the sprocket.

19. The camshaft phaser of claim 15, wherein each of the first elastic cushion ring and the second elastic cushion ring have circumferentially alternating convex and concave portions.

20. The camshaft phaser of claim 15, wherein the first elastic cushion ring and the second elastic cushion ring are configured to directly contact a radial inner side of the chain.
